(19) United States
(12) Patent Application Publication
(10) Pub. No.: US 2015/0346913 A1
(43) Pub. Date: Dec. 3, 2015

(54) METHODS AND SYSTEM FOR MEMORY EFFICIENT IMAGE DISPLAY

(71) Applicant: Apple Inc., Cupertino, CA (US)

(72) Inventor: Eric M. Circlaeys, Paris (FR)

(21) Appl. No.: 14/725,473

(22) Filed: May 29, 2015

Related U.S. Application Data
(60) Provisional application No. 62/005,584, filed on May 30, 2014.

(51) Int. Cl. G06F 3/0481; G06F 3/0484

(52) U.S. Cl. CPC G06F 3/0481; G06F 3/04842

(57) ABSTRACT

A system and method for rearranging thumbnail image display in response to a change in live window size. For a plurality of thumbnail images, the electronic device concatenates the plurality of images into two or more intermediate thumbnail image strips. The electronic device then arranges the two or more intermediate thumbnail image strips into one or more rows based on the current display window size. The electronic device detects change of the display window size from the current display window size to a new display window size. In accordance with detecting a change of the display window size, the electronic device re-arranges the two or more intermediate thumbnail image strips into a new row configuration without reloading the plurality of thumbnail images.

### CLAIM OF PRIORITY

This application claims priority to U.S. Provisional Patent Application No. 62/005,584 entitled “METHODS AND SYSTEM FOR MEMORY EFFICIENT IMAGE DISPLAY” filed May 30, 2014 which is incorporated herein by reference in its entirety.

### TECHNICAL FIELD

The disclosed embodiments relate generally to the field of user interfaces, and in particular to image display techniques.

### BACKGROUND

Viewing images is a popular use for modern electronics. However, viewing and interacting with images can be extremely taxing on the memory and processing power of the electronic device. This is especially true when simultaneously viewing as significant number of images. Thus, when viewing multiple images (e.g., photos) in a single window, it is important to ensure that the algorithms that help display the pictures function quickly and efficiently.

This is especially true when the images need to be dynamically altered in size or position in the display. Many electronic devices ensure that the processor and memory are not over taxed by restricting functions available to the user.

### DESCRIPTION OF THE DRAWINGS

Some embodiments are illustrated by way of example and not limitation in the Figures of the accompanying drawings, in which:

FIG. 1A is a user interface diagram illustrating an example of a user interface displaying a live window that includes a plurality of image thumbnails, according to some embodiments.

FIG. 1B is a user interface diagram illustrating an example of a user interface displaying a live window that includes a plurality of image thumbnails, according to some embodiments.

FIG. 2A is a block diagram illustrating an electronic device in accordance with some embodiments.

FIG. 2B is a block diagram illustrating an electronic device in accordance with some embodiments.

FIG. 3 is a flow diagram illustrating a method for arranging and presenting image files in accordance with some embodiments.

FIG. 4A is a block diagram illustrating the how short image strips are used to build the displayed results in accordance with some embodiments.

FIG. 4B is a block diagram illustrating the memory layout of thumbnail images when a page resize occurs in accordance with some embodiments.

FIG. 5 is a flow diagram illustrating a method for updating a thumbnail image files in accordance with some embodiments.

FIG. 6A is a flow diagram illustrating a method, in accordance with some example embodiments, for memory efficient image display.

FIG. 6B is a flow diagram illustrating a method, in accordance with some example embodiments, for memory efficient image display.

FIG. 7 is a block diagram illustrating an architecture of software which may be installed on any one or more of the devices of FIGS. 2A and 2B.

FIG. 8 is a block diagram illustrating components of a machine, according to some example embodiments, able to read instructions from a machine-readable medium (e.g., a machine-readable storage medium) and perform any one or more of the methodologies discussed herein.

Like reference numerals refer to corresponding parts throughout the drawings.

### DETAILED DESCRIPTION

The present disclosure describes methods, systems and computer program products for displaying images in response to the resizing of windows. In the following description, for purposes of explanation, numerous specific details are set forth to provide a thorough understanding of the various aspects of different embodiments. It will be evident, however, to one skilled in the art, that the any particular embodiment may be practiced without all of the specific details and/or with variations permutations and combinations of the various features and elements described herein.

In one use case, a plurality of images are displayed as thumbnails in a live window and the live window is then resized by a user. In response, the system can either keep the thumbnails the same size and dynamically change the number of columns or fix the number of columns but change the size of the images (aspect ratio remains the same).

In some example embodiments the system maintains the same number of columns as the user resizes a window. However, if all the images needed to be moved on the screen separately, the result would be a large number of load and draw operations. When the number of load and draw operations grows too large, the system performance degrades and results in a substandard user experience.

The system reduces the number of operations that are needed when resizing occurs, the system first preprocesses the images to concatenate several images into a single intermediate image strip from single images. For example, if there are 50 display thumbnail images, the system concatenates them into 10 intermediate strips of 5 images.

When a resizing command occurs, the system only has to execute ten load and draw operations rather than the original possibility of fifty. Thus on average, concatenating images into an intermediate strip results in significant benefits in memory usage and processor resource usage.

In some example embodiments the system receives an order to display a plurality of thumbnail images. In response, the system first concatenates the images into one or more intermediate image strips. The intermediate strips are then used to be displayed in larger rows in a resizable window.

When a resizing order comes, the system avoids loading any individual image in the plurality of thumbnail images. Instead, the system merely loads and reorders the intermediate image strips in the display. In some example embodiments the image strips won't fit nicely into the new row size. For example, if the resized length is 10 images long (e.g., 10 thumbnail images fit in a single row) and the thumbnail strip images have 3 thumbnail images, the each row holds three and one third images.

For each image strip that is split over two rows, the system loads the strip once and draws the strips from the same texture but draws to different rows based on the need.

Furthermore, when a specific thumbnail image needs to be updated, the system only needs to load the new thumbnail into the correct intermediate image strip. Then the appropriate intermediate image is redrawn and none of the other intermediate image strips need to be loaded or redrawn. For example, there are 12 total images in 3 intermediate strips. Image A is changed and its thumbnail needs to be updated. The system determines that intermediate strip 1 contains Image A. Intermediate strip 1 is updated to include the updated version of Image A. The system then redraws intermediate strip 1 at the correct position.

In some example embodiments, when a live update occurs a thumbnail is refreshed only the short strip is updated with the new thumbnail drawing on top of the existing one (which does not require to reload the other thumbnails).

For even faster reload and an improved experience, these strips are saved on disk to be directly reloaded when necessary if available, in order to avoid expensive load operations for individual images, which can be expensive in terms of system resources. The system can also save the version of the thumbnails, hence when reloading from disk it can quickly compare if any of the thumbnails have changed on the local data source and invalidate exactly the thumbnails needed for refresh. The short strips are using a recycling disk cache and a hash filename related to the concatenation of cells identifiers.

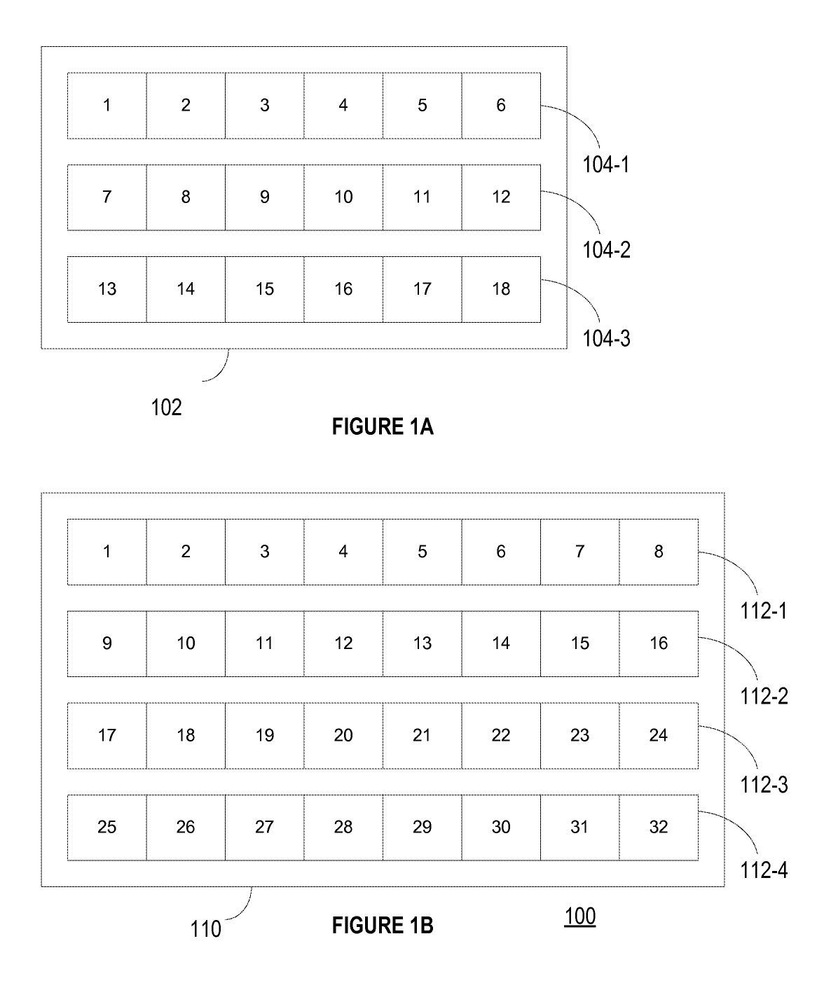

FIG. 1A is a user interface diagram illustrating an example of a user interface 100 displaying a live window that includes a plurality of image thumbnails, according to some embodiments.

As seen in FIG. 1A, the user interface 100 includes a live window 102 at a first size. Inside the live window are 18 thumbnail images (1 to 18) arranged in three rows 104-1 to 104-3. Each row includes 6 thumbnail images that are all the same size and are equally spaced.

In some example embodiments, each thumbnail image is a visual depiction of a larger (or more detailed image) that is displayed to allow review of a plurality of images simultaneously.

FIG. 1B is a user interface diagram illustrating an example of a user interface 100 displaying a live window that includes a plurality of image thumbnails, according to some embodiments.

FIG. 1B represents the user interface shown in FIG. 1A when the live window has been increased in size. As can be seen in FIG. 1B, in response to being resized, the rows in the live window were increased to be eight thumbnail images long and an additional row was added. Now, thumbnail images 1-32 are displayed and there are four rows 112-1 to 112-4. Furthermore, images that were previously display on lower rows were moved up to fill out rows to their new length.

In this example, thumbnail images 7 and 8 (display in row 104-2 in Figure A) are now display in row 112-1. Similar changes have been made to all the thumbnail images as the rows and images were reorganized. Some images that weren't show in FIG. 1A because space restraints are now visible (e.g., thumbnail images 25-32).

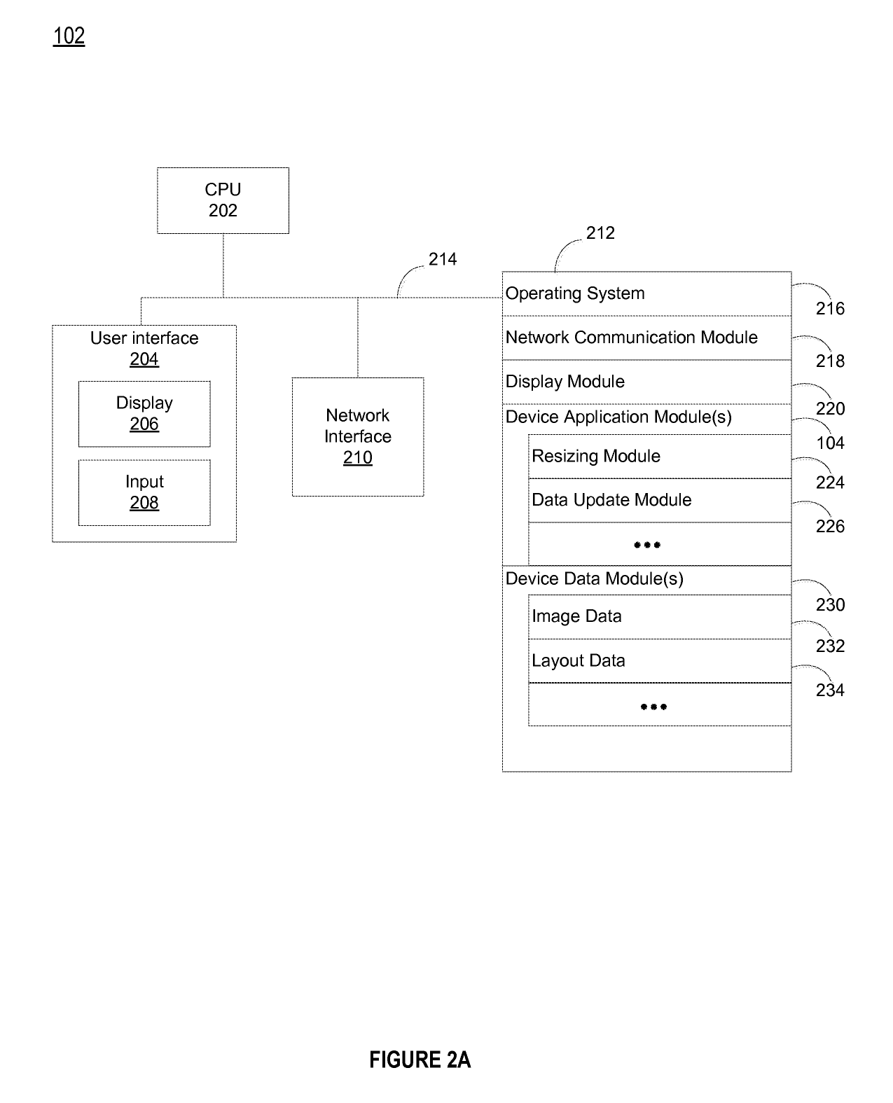

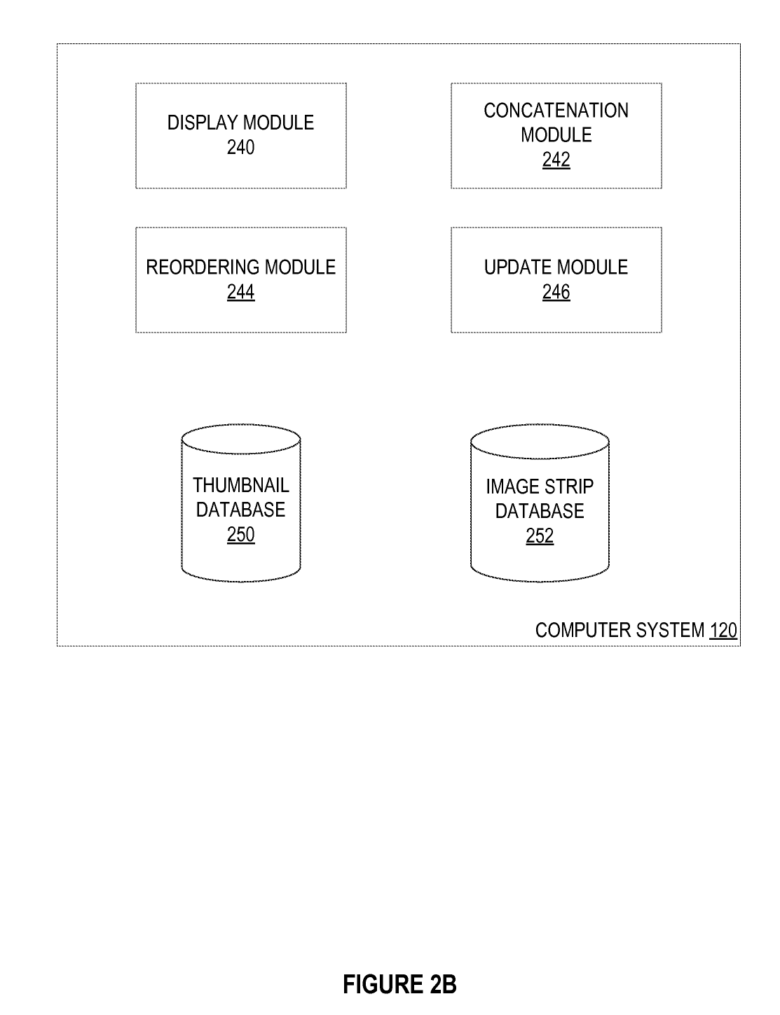

FIG. 2 is a block diagram illustrating an electronic device 102 in accordance with some embodiments. The electronic device 102 typically includes one or more processing units (CPU's) 202, one or more network interfaces 210, memory 212, and one or more communication buses 214 for interconnecting these components. The electric device 102 includes a user interface 204. The user interface 204 includes a display device 206 and optionally includes an input means such as a keyboard, mouse, a touch sensitive display, or other input buttons 208. Furthermore, some electronic devices 102 use a microphone and voice recognition to supplement or replace the keyboard.

Memory 212 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 212 may optionally include one or more storage devices remotely located from the CPU(s) 202. Memory 212, or alternately the non-volatile memory device(s) within memory 212, comprises a non-transitory computer readable storage medium.

In some embodiments, memory 212 or the computer readable storage medium of memory 212 stores the following programs, modules and data structures, or a subset thereof:
an operating system 216 that includes procedures for handling various basic system services and for performing hardware dependent tasks;
a network communication module 218 that is used for connecting the electronic device 102 to other computers via the one or more communication network interfaces 210 (wired or wireless) and one or more communication networks, such as the Internet, other wide area networks, local area networks, metropolitan area networks, etc.;
a display module 220 for enabling the information generated by the operating system 216 and device application modules 104 to be presented visually on the display 206;
one or more device application modules 104 for handling various services of the electronic device 102, including but not limited to:
   a resizing module 224 for detecting a window resizing command and updating the thumbnail image layout in response, including but not limited creating intermediate image strips as needed, calculating a new number of rows to create, and laying out the intermediate image strips in accordance with the space allocated in the newly resized live window; and
   a data update module 226 for detecting when an image has been updated and replacing the old thumbnail images with the updated thumbnail image;
a device data module 230, for storing data relevant to the electronic device 102, including but not limited to:
   image data 232 that includes each stored image file, its thumbnail, and the intermediate image strips; and
   layout data 234 that includes a layout plan for all the thumbnail strips currently displayed in the user interface.

FIG. 2B is a block diagram depicting a computer system 120, in accordance with some example embodiments. The computer system 120 includes a display module 24, a concatenation module 242, a reordering module 244, and an update module 246. In some example embodiments, the computer system 120 also is connected to one or more third party systems (not shown) through a communication network (also not shown). The communication network may be any of a variety of network types, including local area networks (LANs), wide area networks (WANs), wireless networks, wired networks, the Internet, personal area networks (PANs), or a combination of such networks.

As shown by way of example in FIG. 1, the computer system 120 includes one or more data storage devices (e.g., thumbnail database 250 and image strip database 252.)

In some example embodiments, the display module 240 accesses the thumbnail database 250 to retrieve one or more thumbnail images or accesses the image strip database 252 to access one or more image strip database 252. The display module 240 then organizes the thumbnail images or image strips to be displayed on a display associated with the computer system 120. In some cases, the display module 240 organizes display of the thumbnails or image strips based on the metadata associated with each thumbnail or image strip such that the thumbnails are sorted by date, name, topic, and so on.

In some example embodiments, the display module 240 organizes the images strips into a series of rows, such that the number of rows is determined based on the size of the available window and the size of the image strips.

The concatenation module 242 accesses the thumbnail database 250 to retrieve one or more thumbnail images based on the display order determined by the display module 240. The concatenation module 242 creates one or more image strips by creating images that include a plurality of thumbnail images. Each image strip includes a fixed number of thumbnail images. For example, each image strip includes five thumbnail images concatenated into a single image. Each created image strip is then stored in the image strip database 252.

The reordering module 244 receives a change to the window size or magnification level for the thumbnail images and, in response, reorders the thumbnails displayed on the user interface. In some example embodiments, the reordering module 244 alters either the number of displayed rows or the number of images displayed in a given row of thumbnails. When the number of images displayed per row is changed, the reordering module uses the image strip database 252 images to move the location of a plurality of image thumbnails without having to reload and reposition each individual thumbnail image.

The update module 246 determines that a first thumbnail image needs to be updated (e.g., the thumbnail images associated with a larger image or other file is changed). The update module 246 determines which image strip includes the first thumbnail image that needs to be updated. The update module 246 then retrieves the determined image strip from the image strip database 252. In some example embodiments, the update module 246 determines the other thumbnail images included in the determined image strip along with the thumbnail image that needs to be updated.

In some example embodiments, the update module 246 then uses the concatenation module 242 to create an updated version of the image strip that includes the updated version of the first thumbnail image and the other thumbnail images that were included in the original image strip. The updated image strip is the displayed in the appropriate location on the display by the display module240 and stored in the image strip database 252.

The image thumbnail database 250 includes one or more thumbnail images, each thumbnail image being associated with an image, file, media content item, or other item or file available on the computer system 120.

In some example embodiments, the image strip database 252 includes a plurality of image strips. An image strip is an image that includes a plurality of thumbnail images as part of a single image (e.g., arranged in a strip of thumbnail images).

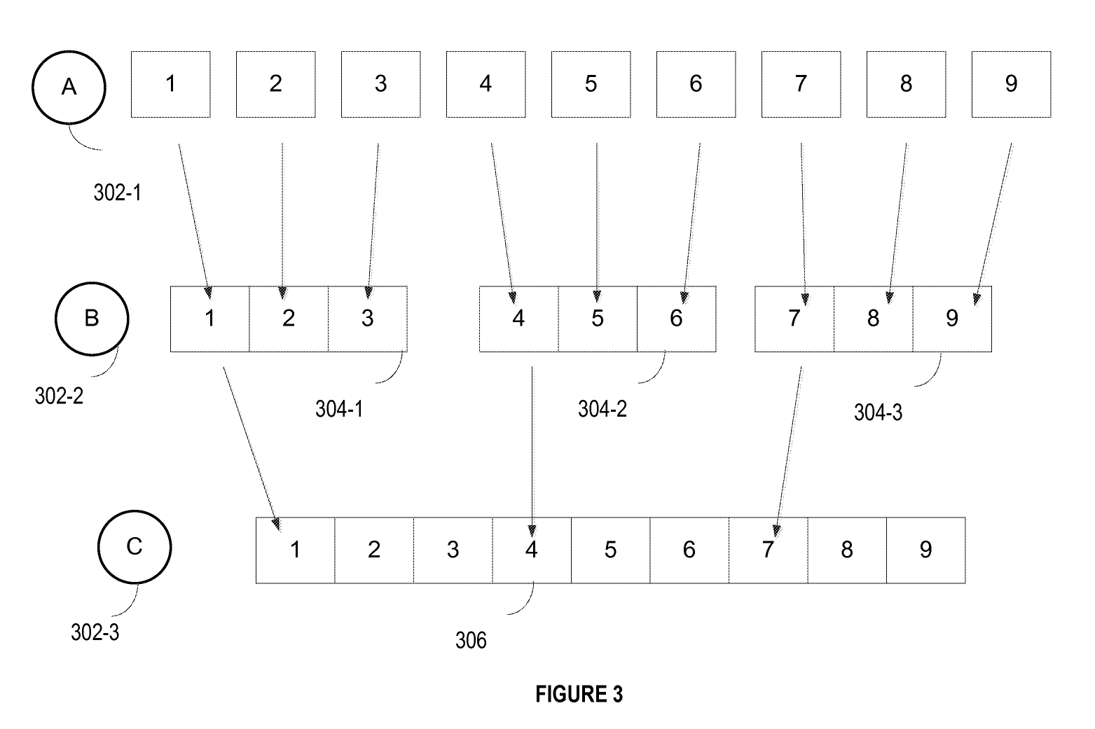

FIG. 3 is a flow diagram illustrating a method for arranging and presenting image files in accordance with some embodiments. In some embodiments, the method described in FIG. 3 is performed by electronic device.

In some example embodiments the scrolling pipeline is responsible to pre-fetch these short image strips in advance, which requires the system to load the thumbnails and compose them asynchronously. The short image strips are finally assembled to produce one visible plain row. In this example, a 3 step process per row is used.

The electronic device starts with a plurality of thumbnail images (1-12). The first step 302-1 (Operation A) includes concatenating several single thumbnail images (1-12) into one or more intermediate image strip (or just short image strips). Thus, the electronic device creates one or more short image strips 304-1 to 304-3. The electronic device then arranges 302-2 (Operation B) two or more short image strips into a single row 306 for the display. The size and length of the row are dictated by device settings, user preferences, and the size of the live window. The single row 306 is then drawn on the display (Operation C) 302-3.

In some example embodiments steps B and C are dependent on each other and are pushed to parallel operations queues for scheduling. In some example embodiments step A operations are synchronous sub-operations executed as part of the B operation (for batch and possible optimized alignment thumbnail loading).

In some example embodiments the composed shorter strips (result of step B operations) are kept in the least recently used memory over resize since they can be re-used but the rows are composed live on scrolling/resize in this example.

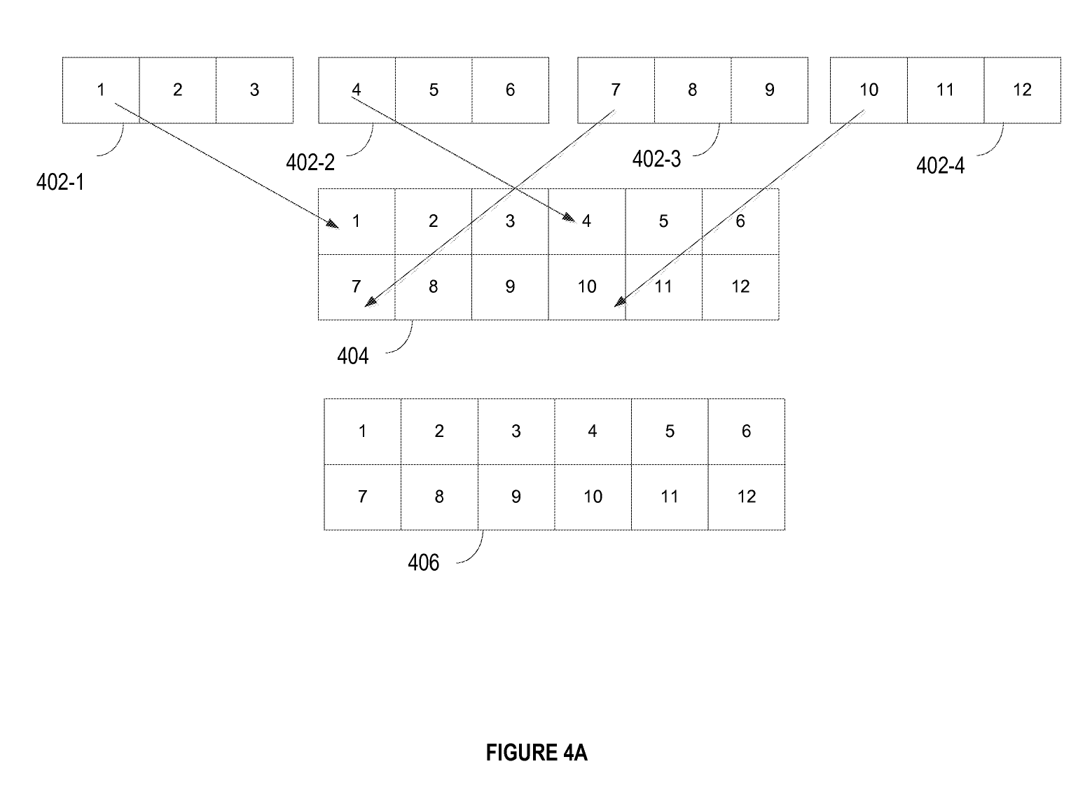

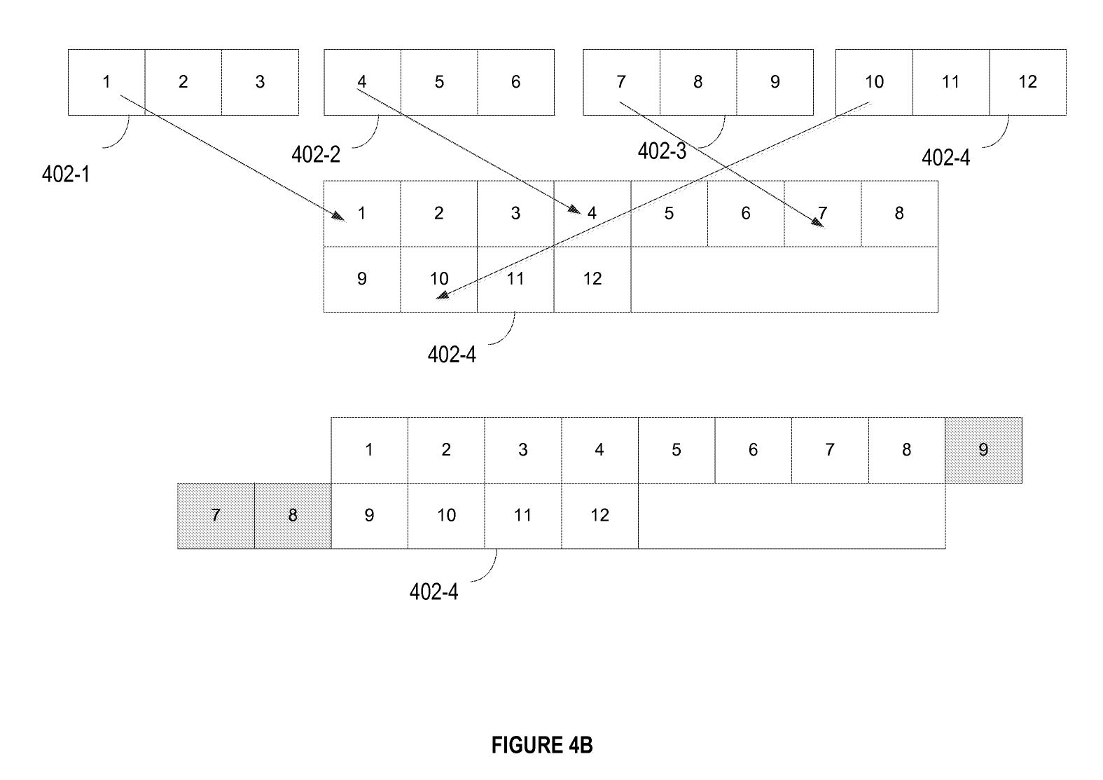

FIG. 4A is a block diagram illustrating how short image strips are used to build the displayed results in accordance with some embodiments. There are four short image strips 402-1 to 402-4 that each include three thumbnail images.

In some example embodiments the short image strips 402-1 to 402-4 are organized in memory layout to have two rows of 6 thumbnail images each. As a result, the displayed rows also have 2 rows with 6 thumbnail images each.

FIG. 4B is a block diagram illustrating the memory layout of thumbnail images when a page resize occurs in accordance with some embodiments. Similar to FIG. 4A, there are four short image strips 402-1 to 402-4. However, the display row size has increased in response to an increase in the live page size. As a result, the thumbnail images can to be reorganized. The first two short image strips 402-1 and 402-2 remain in the same place, both in memory 410 and on the display 412.

However, the third short image strip 402-3 has been partially moved up to row one. Because there isn't enough room on row one, the third short image strip 402-3 is shared between the first row and the second row. Strips shared between rows are loaded once and drawn from the same texture but with difference contents rectangle. In this way, image 7 is loaded from the third short image strip 402-3 but drawn on row one, while 8 and 9 are drawn in row 2. In some example embodiments the strip is positioned at two positions in memory once it is loaded so that its components can be easily used in both rows.

As a result, the displayed rows 412 show 8 image thumbnails in the first row and 4 in the second row. In memory 410, each thumbnail image strip is only loaded once, saving on memory and time.

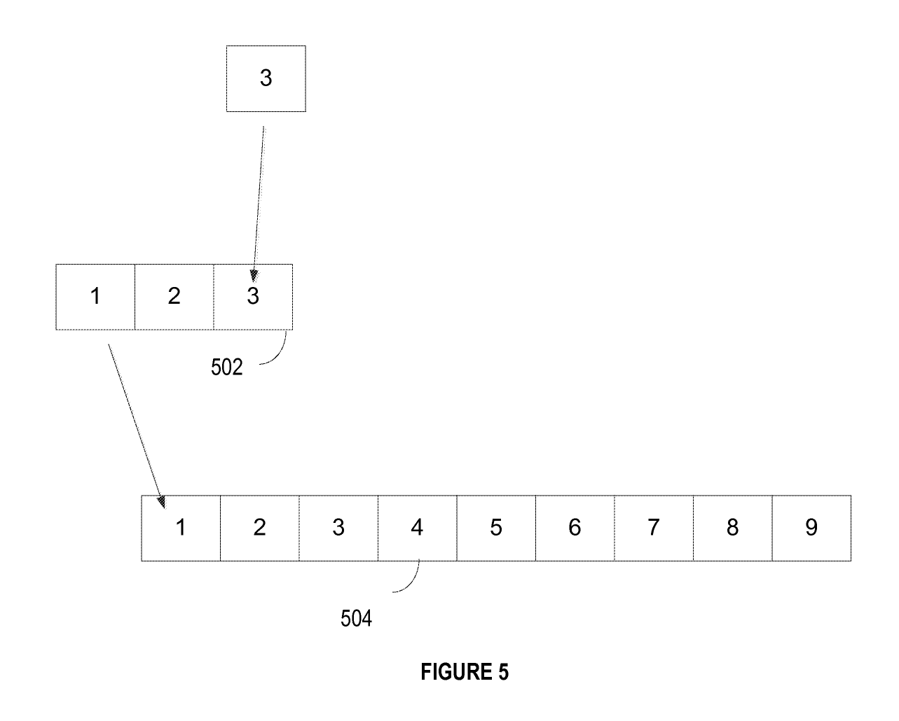

FIG. 5 is a flow diagram illustrating a method for updating a thumbnail image files in accordance with some embodiments. In this case, a single thumbnail has changed and needs to be updated (Image 3). However, if only one thumbnail needs to be updated, it is important to minimize the amount of memory and resources used to update that single image.

The electronic system first identifies the short image strip that includes the updated thumbnail image. In this case it's short image strip 502. The system then updates only that short image strip. Once the appropriate short image strip has been updated, the short image strip is then written into the appropriate memory and display in the appropriate row to update the correct thumbnail images in the associated row 504.

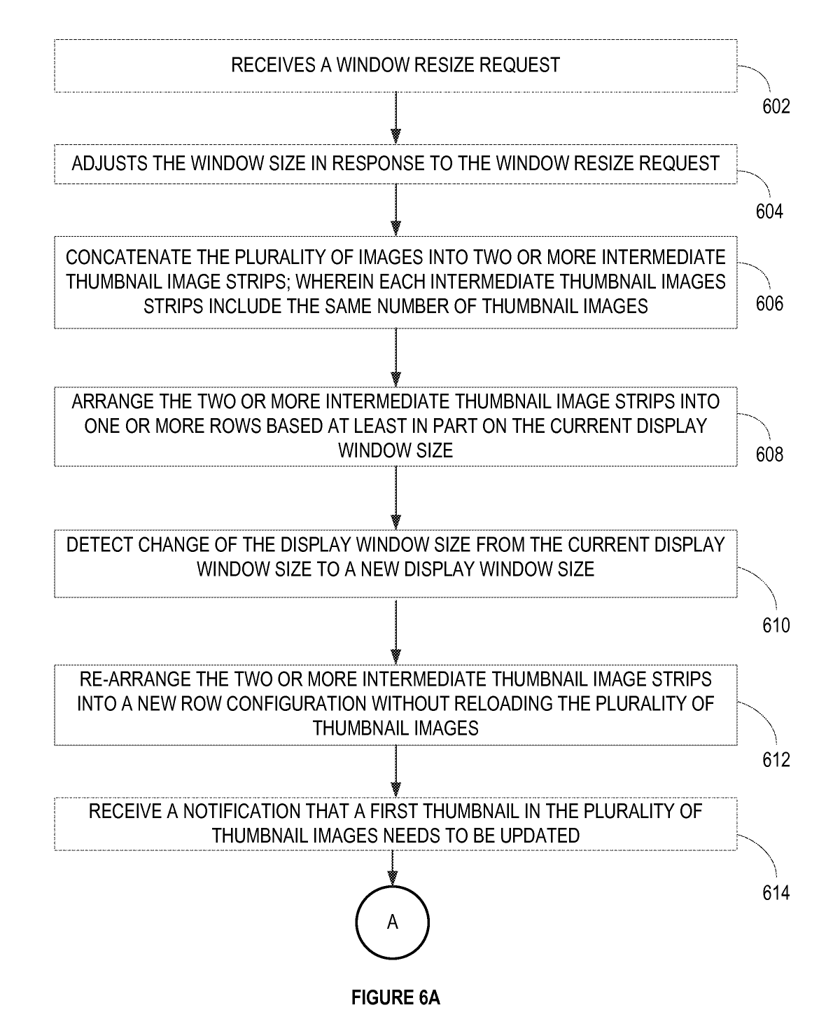

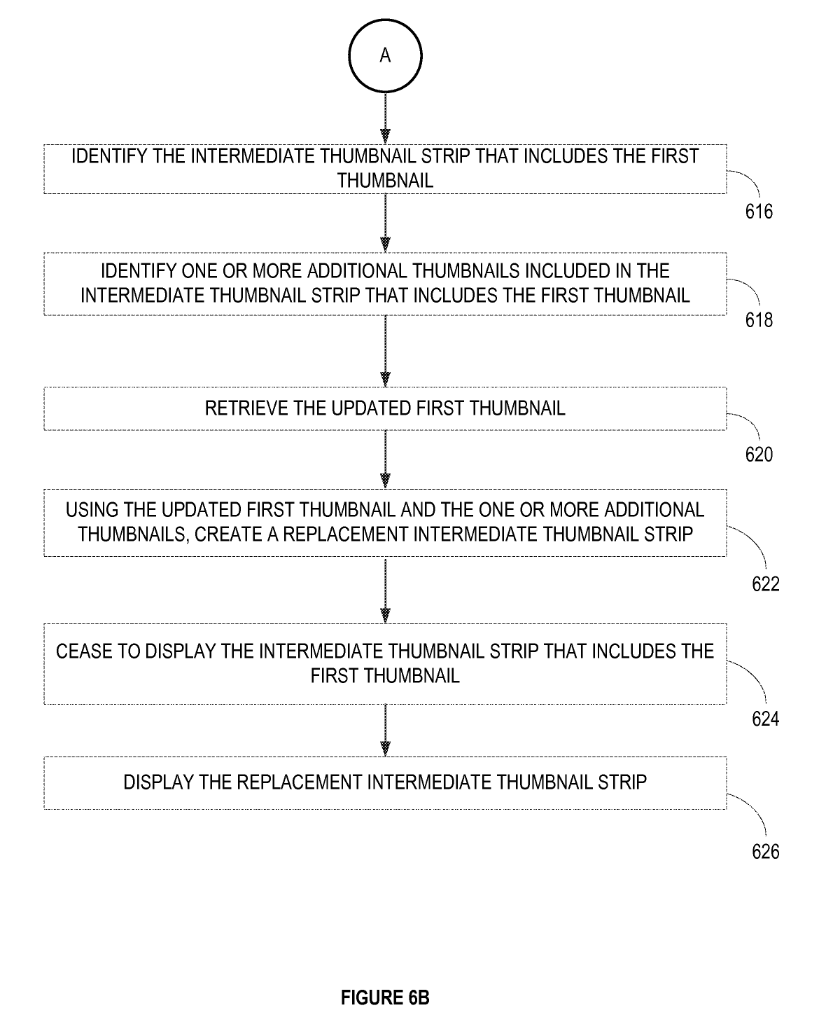

FIG. 6A is a flow diagram illustrating a method, in accordance with some example embodiments, for memory efficient image display. Each of the operations shown in FIG. 6A may correspond to instructions stored in a computer memory or computer-readable storage medium. Optional operations are indicated by dashed lines (e.g., boxes with dashed-line borders). In some embodiments, the method described in FIG. 6A is performed by the computer system (e.g., the computer system 120 in FIG. 1). However, the method described can also be performed by other combinations of specially configured electronic hardware.

In some embodiments the method is performed at a computer system (e.g., the computer system 120 in FIG. 1) including one or more processors and memory storing one or more programs for execution by the one or more processors.

In some example embodiments, the computer system (e.g., the computer system 120 in FIG. 1) receives (602) a window resize request. For example, a display window is presented in a user interface associated with the computer system 120. In some user interface windows, a plurality of thumbnail images (e.g., each of which represents an application, an image, a media content item, or other file). A window resize request is a request to change the size of the window within the user interface (e.g., either enlarge the window in size or reduce the window in size). In some example embodiments, the size of the thumbnails is changed by zooming in or out.

In some cases the window resize request is generated based on input received from a user through a touch screen interface. The computer system (e.g., the computer system 120 in FIG. 1) adjusts (604) the window size in response to the window resize request.

In some example embodiments, the computer system (e.g., the computer system 120 in FIG. 1), for a plurality of thumbnail images, concatenates (606) the plurality of images into two or more intermediate thumbnail image strips; wherein each intermediate thumbnail images strips include the same number of thumbnail images. For example, each thumbnail image strips includes four thumbnail images. In some example embodiments, the strip size for the intermediate thumbnail image strips is determined by running simulations from the different supported window bounds and sizes to find the proper balance between drawing performance and input/output for the computer system (e.g., the computer system 120 in FIG. 1).

In some example embodiments, the computer system (e.g., the computer system 120 in FIG. 1) arranges (608) the two or more intermediate thumbnail image strips into one or more rows based at least in part on the current display window size.

In some example embodiments, the computer system (e.g., the computer system 120 in FIG. 1) detects (610) change of the display window size from the current display window size to a new display window size. As noted above, in some cases a windows resize request is received in response to user input on a touch screen display. In other cases, the computer system automatically resizes a window based on programmatic response to internal or external inputs.

In some example embodiments, in accordance with detecting a change of the display window size, the computer system (e.g., the computer system 120 in FIG. 1) re-arranges (612) the two or more intermediate thumbnail image strips into a new row configuration without reloading the plurality of thumbnail images.

In some example embodiments, the computer system (e.g., the computer system 120 in FIG. 1) receives (614) a notification that a first thumbnail in the plurality of thumbnail images needs to be updated. For example, when a file is updated the computer system (e.g., the computer system 120 in FIG. 1) determines whether the accompanying thumbnail image needs to be updated. If so, the computer system (e.g., the computer system 120 in FIG. 1) sends a notification to the display module identifying the specific thumbnail that needs to be updated.

FIG. 6B is a flow diagram illustrating a method, in accordance with some example embodiments, for memory efficient image display. Each of the operations shown in FIG. FIG. 6B may correspond to instructions stored in a computer memory or computer-readable storage medium. Optional operations are indicated by dashed lines (e.g., boxes with dashed-line borders). In some embodiments, the method described in FIG. FIG. 6B is performed by the computer system (e.g., the computer system 120 in FIG. 1). However, the method described can also be performed by other combinations of specially configured electronic hardware.

In some embodiments the method is performed at a computer system (e.g., the computer system 120 in FIG. 1) including one or more processors and memory storing one or more programs for execution by the one or more processors.

In some example embodiments, the computer system (e.g., the computer system 120 in FIG. 1) identifies (616) the intermediate thumbnail strip that includes the first thumbnail. For example, the computer system 120 stores metadata describing the specific thumbnails included in each thumbnail strip. The computer system then uses the thumbnail identification number for the updated thumbnail to identify the image strip that includes the updated thumbnail.

In some example embodiments, the computer system (e.g., the computer system 120 in FIG. 1) identifies (618) one or more additional thumbnails included in the intermediate thumbnail strip that includes the first thumbnail. For example, once the intermediate thumbnail strip that includes the updated thumbnail image is determines, the computer system (e.g., the computer system 120 in FIG. 1) uses the metadata for the intermediate thumbnail strip to identify the other thumbnail images that are includes in the intermediate thumbnail strip.

In some example embodiments, the computer system (e.g., the computer system 120 in FIG. 1) retrieves (620) the updated first thumbnail image. For example the computer system (e.g., the computer system 120 in FIG. 1) determines where the updated thumbnail is located. In some example embodiments, the computer system (e.g., the computer system 120 in FIG. 1) generates a new thumbnail image based on updated data for the file with which the thumbnail image is associated.

In some example embodiments, using the updated first thumbnail and the one or more additional thumbnails, the computer system (e.g., the computer system 120 in FIG. 1) creates (622) a replacement intermediate thumbnail strip. For example, a thumbnail strip includes thumbnail images A, B, and C. When thumbnail image B is updated, the computer system 120 recreates the intermediate thumbnail strip such that it includes thumbnail image A, newly updated thumbnail image B, and thumbnail image C.

In some example embodiments, the computer system (e.g., the computer system 120 in FIG. 1) ceases (624) to display the intermediate thumbnail strip that includes the first thumbnail. The computer system 120 then displays (626) the replacement intermediate thumbnail strip.

### Software Architecture

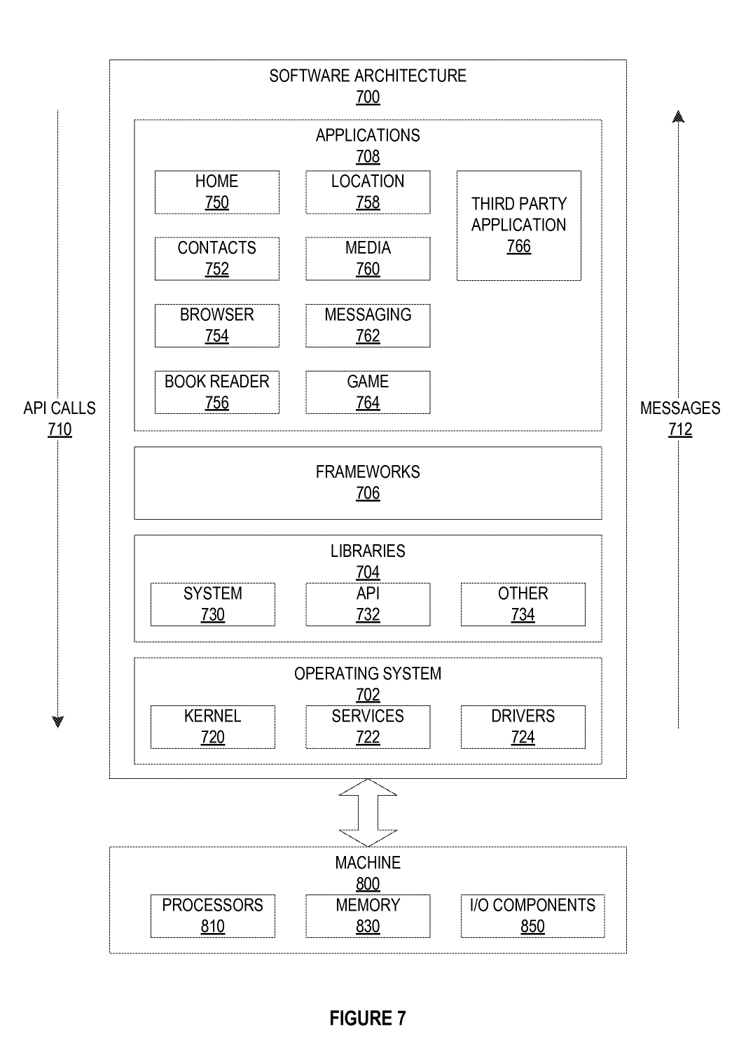

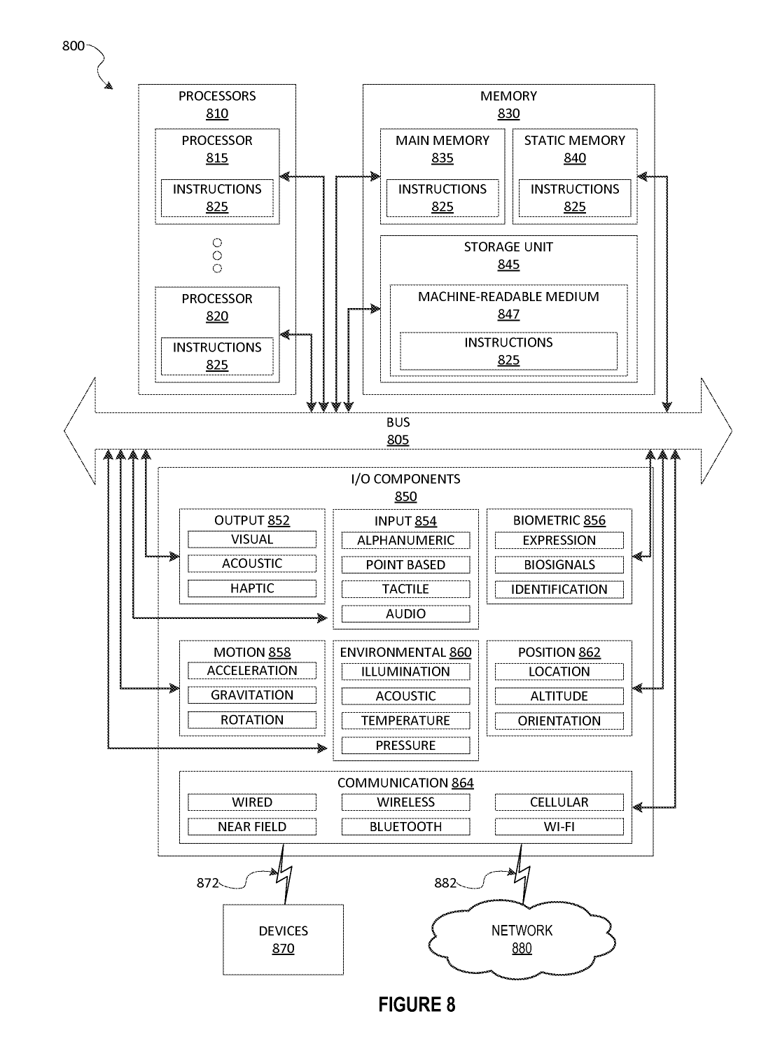

FIG. 7 is a block diagram illustrating an architecture of software 700, which may be installed on any one or more of the devices of FIG. 1 (e.g., client device(s) 110). FIG. 7 is merely a non-limiting example of a software architecture and it will be appreciated that many other architectures may be implemented to facilitate the functionality described herein. The software 700 may be executing on hardware such as machine 800 of FIG. 8 that includes processors 810, memory 830, and I/O components 850. In the example architecture of FIG. 7, the software 700 may be conceptualized as a stack of layers where each layer may provide particular functionality. For example, the software 700 may include layers such as an operating system 702, libraries 704, frameworks 706, and applications 708. Operationally, the applications 708 may invoke API calls 710 through the software stack and receive messages 712 in response to the API calls 710.

The operating system 702 may manage hardware resources and provide common services. The operating system 702 may include, for example, a kernel 720, services 722, and drivers 724. The kernel 720 may act as an abstraction layer between the hardware and the other software layers. For example, the kernel 720 may be responsible for memory management, processor management (e.g., scheduling), component management, networking, security settings, and so on. The services 722 may provide other common services for the other software layers. The drivers 724 may be responsible for controlling and/or interfacing with the underlying hardware. For instance, the drivers 724 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth.

The libraries 704 may provide a low-level common infrastructure that may be utilized by the applications 708. The libraries 704 may include system libraries 730 (e.g., C standard library) that may provide functions such as memory allocation functions, string manipulation functions, mathematic functions, and the like. In addition, the libraries 704 may include API libraries 732 such as media libraries (e.g., libraries to support presentation and manipulation of various media formats such as MPREG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 704 may also include a wide variety of other libraries 734 to provide many other APIs to the applications 708.

The frameworks 706 may provide a high-level common infrastructure that may be utilized by the applications 708. For example, the frameworks 706 may provide various graphical user interface (GUI) functions, high-level resource management, high-level location services, and so forth. The frameworks 706 may provide a broad spectrum of other APIs that may be utilized by the applications 708, some of which may be specific to a particular operating system or platform.

The applications 708 include a home application 750, a contacts application 752, a browser application 754, a book reader application 756, a location application 758, a media application 760, a messaging application 762, a game application 764, and a broad assortment of other applications such as third party application 766. In a specific example, the third party application 766 (e.g., an application developed using the Android™ or iOS™ software development kit (SDK) by an entity other than the vendor of the particular platform) may be mobile software running on a mobile operating system such as iOS™, Android™ Windows® Phone, or other mobile operating systems. In this example, the third party application 766 may invoke the API calls 710 provided by the mobile operating system 702 to facilitate functionality described herein.

### Example Machine Architecture and Machine-Readable Medium

FIG. 8 is a block diagram illustrating components of a machine 800, according to some example embodiments, able to read instructions from a machine-readable medium (e.g., a machine-readable storage medium) and perform any one or more of the methodologies discussed herein. Specifically, FIG. 8 shows a diagrammatic representation of the machine 800 in the example form of a computer system, within which instructions 825 (e.g., software, a program, an application, an applet, an app, or other executable code) for causing the machine 800 to perform any one or more of the methodologies discussed herein may be executed. In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but be not limited to, a server computer, a client computer, a (PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 825, sequentially or otherwise, that specify actions to be taken by machine 800. Further, while only a single machine 800 is illustrated, the term “machine” shall also be taken to include a collection of machines 800 that individually or jointly execute the instructions 825 to perform any one or more of the methodologies discussed herein.

The machine 800 may include processors 810, memory 830, and I/O components 850, which may be configured to communicate with each other via a bus 805. In an example embodiment, the processors 810 (e.g., a CPU, a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 815 and processor 820, which may execute instructions 825. The term “processor” is intended to include multi-core processor that may comprise two or more independent processors (also referred to as “cores”) that may execute instructions contemporaneously. Although FIG. 8 shows multiple processors, the machine 800 may include a single processor with a single core, a single processor with multiple cores (e.g., a multi-core process), multiple processors with a single core, multiple processors with multiples cores, or any combination thereof.

The memory 830 may include a main memory 835, a static memory 840, and a storage unit 845 accessible to the processors 810 via the bus 805. The storage unit 845 may include a machine-readable medium 847 on which are stored the instructions 825 embodying any one or more of the methodologies or functions described herein. The instructions 825 may also reside, completely or at least partially, within the main memory 835, within the static memory 840, within at least one of the processors 810 (e.g., within the processor's cache memory), or any suitable combination thereof, during execution thereof by the machine 800. Accordingly, the main memory 835, static memory 840, and the processors 810 may be considered as machine-readable media 847.

As used herein, the term “memory” refers to a machine-readable medium 847 able to store data temporarily or permanently and may be taken to include, but not be limited to, random-access memory (RAM), read-only memory (ROM), buffer memory, flash memory, and cache memory. While the machine-readable medium 847 is shown in an example embodiment to be a single medium, the term “machine-readable medium” should be taken to include a single medium or multiple media (e.g., a centralized or distributed database, or associated caches and servers) able to store instructions 825. The term “machine-readable medium” shall also be taken to include any medium, or combination of multiple media, that is capable of storing instructions (e.g., instructions 825) for execution by a machine (e.g., machine 800), such that the instructions, when executed by one or more processors of the machine 800 (e.g., processors 810), cause the machine 800 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., Erasable Programmable Read-Only Memory (EPROM)), or any suitable combination thereof. The term “machine-readable medium” specifically excludes non-statutory signals per se.

The I/O components 850 may include a wide variety of components to receive input, provide and/or produce output, transmit information, exchange information, capture measurements, and so on. It will be appreciated that the I/O components 850 may include many other components that are not shown in FIG. 8. In various example embodiments, the I/O components 850 may include output components 852 and/or input components 854. The output components 852 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 854 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, and/or other pointing instrument), tactile input components (e.g., a physical button, a touch screen that provide location and force of touches or touch gestures, and/or other tactile input components), audio input components (e.g., a microphone), and the like.

In further example embodiments, the I/O components 850 may include biometric components 856, motion components 858, environmental components 860, and/or position components 862, among a wide array of other components. For example, the biometric components 856 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, finger print identification, or electroencephalogram based identification), and the like. The motion components 858 may include acceleration sensor components (e.g., accelerometer), gravitation sensor components, rotation sensor components (e.g., gyroscope), and so forth. The environmental components 860 may include, for example, illumination sensor components (e.g., photometer), acoustic sensor components (e.g., one or more microphones that detect background noise), temperature sensor components (e.g., one or more thermometers that detect ambient temperature), humidity sensor components, pressure sensor components (e.g., barometer), proximity sensor components (e.g., infrared sensors that detect nearby objects), and/or other components that may provide indications, measurements, and/or signals corresponding to a surrounding physical environment. The position components 862 may include location sensor components (e.g., a Global Position System (GPS) receiver component), altitude sensor components (e.g., altimeters and/or barometers that detect air pressure from which altitude may be derived), orientation sensor components (e.g., magnetometers), and the like.

Communication may be implemented using a wide variety of technologies. The I/O components 850 may include communication components 864 operable to couple the machine 800 to a network 880 and/or devices 870 via coupling 882 and coupling 872, respectively. For example, the communication components 864 may include a network interface component or other suitable device to interface with the network 880. In further examples, communication components 864 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 870 may be another machine and/or any of a wide variety of peripheral devices (e.g., a peripheral device couple via a USB).

Moreover, the communication components 864 may detect identifiers and/or include components operable to detect identifiers. For example, the communication components 864 may include Radio Frequency Identification (RFID) tag reader components, NFC smart tag detection components, optical reader components (e.g., an optical sensor to detect one-dimensional bar codes such as Universal Product Code (UPC) bar codes, multi-dimensional bar codes such as a Quick Response (QR) code, Aztec code, Data Matrix, Dataglyph, MaxiCode, PDF48, Ultra Code, UCC RSS-2D bar code, and other optical codes), acoustic detection components (e.g., microphones to identify tagged audio signals), and so on. In additional, a variety of information may be derived via the communication components 864 such as location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 880 may be an ad hoc network, an intranet, an extranet, a virtual private network (VPN), a LAN, a wireless LAN (WLAN), a WAN, a wireless WAN (WWAN), a MAN, the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 880 or a portion of the network 880 may include a wireless or cellular network and the coupling 882 may be a Code Division Multiple Access (CDMA) connection, a Global System for Mobile communications (GSM) connection, or other type of cellular or wireless coupling. In this example, the coupling 882 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 825 may be transmitted and/or received over the network 880 using a transmission medium via a network interface device (e.g., a network interface component included in the communication components 864) and utilizing any one of a number of well-known transfer protocols (e.g., HyperText Transfer Protocol (HTTP)). Similarly, the instructions 825 may be transmitted and/or received using a transmission medium via the coupling 872 (e.g., a peer-to-peer coupling) to devices 870. The term “transmission medium” shall be taken to include any intangible medium that is capable of storing, encoding, or carrying instructions 825 for execution by the machine 800, and includes digital or analog communications signals or other intangible medium to facilitate communication of such software.

Furthermore, the machine-readable medium 847 is non-transitory (in other words, not having any transitory signals) in that it does not embody a propagating signal. However, labeling the machine-readable medium 847 as “non-transitory” should not be construed to mean that the medium is incapable of movement; the medium should be considered as being transportable from one physical location to another. Additionally, since the machine-readable medium 847 is tangible, the medium may be considered to be a machine-readable device.

### Term Usage

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The foregoing description, for purpose of explanation, has been described with reference to specific implementations. However, the illustrative discussions above are not intended to be exhaustive or to limit the possible implementations to the precise forms disclosed. Many modifications and variations are possible in view of the above teachings. The implementations were chosen and described in order to best explain the principles involved and their practical applications, to thereby enable others skilled in the art to best utilize the various implementations with various modifications as are suited to the particular use contemplated.

It will also be understood that, although the terms first, second, and so forth may be used herein to describe various elements, these elements should not be limited by these terms. These terms are only used to distinguish one element from another. For example, a first contact could be termed a second contact, and, similarly, a second contact could be termed a first contact, without departing from the scope of the present implementations. The first contact and the second contact are both contacts, but they are not the same contact.

The terminology used in the description of the implementations herein is for the purpose of describing particular implementations only and is not intended to be limiting. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if (a stated condition or event) is detected” may be construed to mean “upon determining” or “in response to determining” or “upon detecting (the stated condition or event)” or “in response to detecting (the stated condition or event),” depending on the context.

What is claimed is:

1. A method comprising:
for a plurality of thumbnail images, concatenating the plurality of images into two or more intermediate thumbnail image strips; wherein each intermediate thumbnail images strips include the same number of thumbnail images;
arranging the two or more intermediate thumbnail image strips into one or more rows based at least in part on the current display window size;
detecting change of the display window size from the current display window size to a new display window size;
in accordance with detecting a change of the display window size, rearranging the two or more intermediate thumbnail image strips into a new row configuration without reloading the plurality of thumbnail images.

2. The method of claim 1, wherein detecting the change of the display window size includes:
receiving a window resize request resizing the current display window size to the new display window size; and
adjusting the window size in response to the window resize request.

3. The method of claim 2, wherein the window resize request is generated based on input from a user.

4. The method of claim 1, further comprising:
receiving a notification that a first thumbnail in the plurality of thumbnail images needs to be updated; and
identifying the intermediate thumbnail strip that includes the first thumbnail; and
identifying one or more additional thumbnails included in the intermediate thumbnail strip that includes the first thumbnail.

5. The method of claim 4, further comprising:
retrieving the updated first thumbnail;
using the updated first thumbnail and the one or more additional thumbnails, creating a replacement intermediate thumbnail strip.

6. The method of claim 5, further comprising:
ceasing to display the intermediate thumbnail strip that includes the first thumbnail; and
displaying the replacement intermediate thumbnail strip.

7. A system comprising:
one or more processors;
memory; and
one or more programs stored in the memory, the one or more programs comprising instructions for:
for a plurality of thumbnail images, concatenating the plurality of images into two or more intermediate thumbnail image strips; wherein each intermediate thumbnail images strips include the same number of thumbnail images;
arranging the two or more intermediate thumbnail image strips into one or more rows based at least in part on the current display window size;
detecting change of the display window size from the current display window size to a new display window size;
in accordance with detecting a change of the display window size, rearranging the two or more intermediate thumbnail image strips into a new row configuration without reloading the plurality of thumbnail images.

8. The system of claim 7, wherein the instructions for detecting the change of the display window size further comprising instructions for:
receiving a window resize request; and
adjusting the window size in response to the window resize request.

9. The system of claim 8, wherein the window resize request is generated based on input from a user.

10. The system of claim 7, further comprising instructions for:
receiving a notification that a first thumbnail in the plurality of thumbnail images needs to be updated; and
identifying the intermediate thumbnail strip that includes the first thumbnail; and
identifying one or more additional thumbnails included in the intermediate thumbnail strip that includes the first thumbnail.

11. The system of claim 10, further comprising instructions for:
retrieving the updated first thumbnail;
using the updated first thumbnail and the one or more additional thumbnails, creating a replacement intermediate thumbnail strip.

12. The system of claim 11, further comprising instructions for:
ceasing to display the intermediate thumbnail strip that includes the first thumbnail; and
displaying the replacement intermediate thumbnail strip.

13. A non-transitory computer readable storage medium storing one or more programs for execution by one or more processors, the one or more programs comprising instructions for:
for a plurality of thumbnail images, concatenating the plurality of images into two or more intermediate thumbnail image strips; wherein each intermediate thumbnail images strips include the same number of thumbnail images;
arranging the two or more intermediate thumbnail image strips into one or more rows based at least in part on the current display window size;
detecting change of the display window size from the current display window size to a new display window size;
in accordance with detecting a change of the display window size, rearranging the two or more intermediate thumbnail image strips into a new row configuration without reloading the plurality of thumbnail images.

14. The non-transitory computer readable storage medium of claim 13, further comprising instructions for:
receiving a window resize request; and
adjusting the window size in response to the window resize request.

15. The non-transitory computer readable storage medium of claim 14, wherein the window resize request is generated based on input from a user.

16. The non-transitory computer readable storage medium of claim 13, further comprising instructions for:
receiving a notification that a first thumbnail in the plurality of thumbnail images needs to be updated; and
identifying the intermediate thumbnail strip that includes the first thumbnail; and
identifying one or more additional thumbnails included in the intermediate thumbnail strip that includes the first thumbnail.

17. The non-transitory computer readable storage medium of claim 16, further comprising instructions for:
retrieving the updated first thumbnail;
using the updated first thumbnail and the one or more additional thumbnails, creating a replacement intermediate thumbnail strip.

18. The non-transitory computer readable storage medium of claim 17, further comprising instructions for:
ceasing to display the intermediate thumbnail strip that includes the first thumbnail; and
displaying the replacement intermediate thumbnail strip.
